(19) United States
(12) Patent Application Publication
(10) Pub. No.: US 2013/0135103 A1
(43) Pub. Date: May 30, 2013

(54) Smart card wallet

(71) Applicant: Jerrell P. Hollaway, Melbourne, FL (US)

(72) Inventor: Jerrell P. Hollaway, Melbourne, FL (US)

(21) Appl. No.: 13/373,647

(22) Filed: Nov. 25, 2011

(51) Int. Cl. G08B 13/14; A45C 1/06

(52) U.S. Cl. 340/568.7; 150/147

(57) ABSTRACT

A card wallet that can detect a missing credit card or driver's license is described. A wallet for holding plastic cards records electronically the addition of cards as well as the removal of cards. Whenever the number of cards in the wallet is less than the recorded number of cards, a signal is sent to the user warning the user that a card is missing. This may be the result of leaving a credit card at a checkout counter, theft, mishandling, or loss. The warning signal is issued only a short time after the last card was removed, aiding in rapid investigation and recovery. A simple method of detecting a missing card is to add the number of incoming cards and subtract the number of outgoing cards. An arrangement of momentary switches is used to determine the direction that the card is moving in the wallet.

### BACKGROUND OF THE INVENTION

1. Field of the Invention

The present invention relates to wallets and other methods of storing and protecting plastic cards used for credit, debit and authorizations, such as driver's licenses.

2. Discussion of Related Art

To date, most methods of organizing and storing credit cards and the like have consisted of plastic sleeves, usually connected together, that can be carried in a purse or wallet. The only method of keeping track of a particular card is to have a dedicated position, or sleeve, where that particular card is to be kept. Then, if that card is missing, it might be noticed by its absence. No system has been devised for providing a visual or audible alarm when a card is missing. Likewise, no foolproof method has been offered for preventing the owner from stacking cards together with magnetic stripes touching, thought to possibly cause erosions of the data stored in the magnetic stripes.

### SUMMARY OF THE INVENTION

The Smart Card Wallet was developed to keep track of all cards stored in a central location and to provide a signal to the owner whenever a card is missing from the central location. This can be done by actually reading certain data contained on, or within the card when is first introduced into the central location and then reading the same data whenever the card is removed.

In a preferred embodiment, each card is counted as it is stored, thereby establishing an expected total number of cards in the central location. Then wherever one or more cards are removed, a new number of remaining cards is established. A microprocessor notes the discrepancy and, after a prescribed delay, sends an alarm for the owner to react to. The advantage of the invention is that the owner can begin a search for the missing card while recovery is most likely.

In this preferred embodiment, a microprocessor and a pair of switches, properly positioned, can detect the direction of the card movement by the order that the switches are activated.

### BRIEF DESCRIPTION OF THE DRAWINGS

FIG. 1 is a functional block diagram of the electrical components of a preferred embodiment.

FIG. 2 illustrates the physical arrangement of a preferred embodiment.

### DETAILED DESCRIPTION OF THE PREFERRED EMBODIMENTS

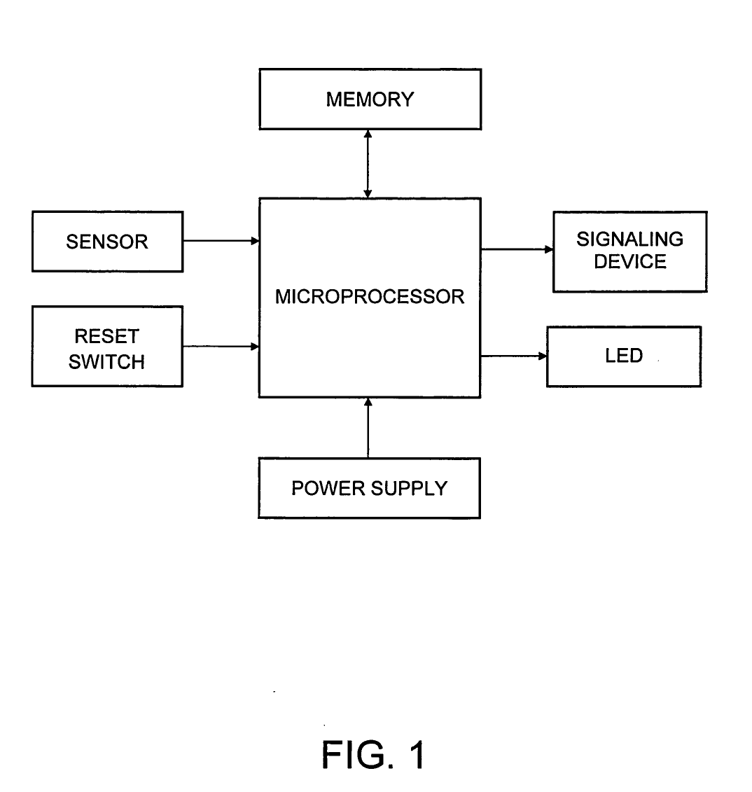

Referring to FIG. 1, the Microprocessor is connected to the Memory, Power Supply, Sensor, LED, Signaling Device and Reset Switch.

Starting with the Power Supply, it can be any source of power suitable for supplying the Microprocessor, LED, Memory, Signaling Device, Sensor and Reset Switch with the proper DC voltages. In the simplest case, this can be a single 3-volt battery. Since the wallet may go unused for days at a time, the microprocessor will put itself to sleep as soon as all cards are safely stowed, thereby extending battery life considerably. A low battery signal can also be sent to the LED or the Signaling Device.

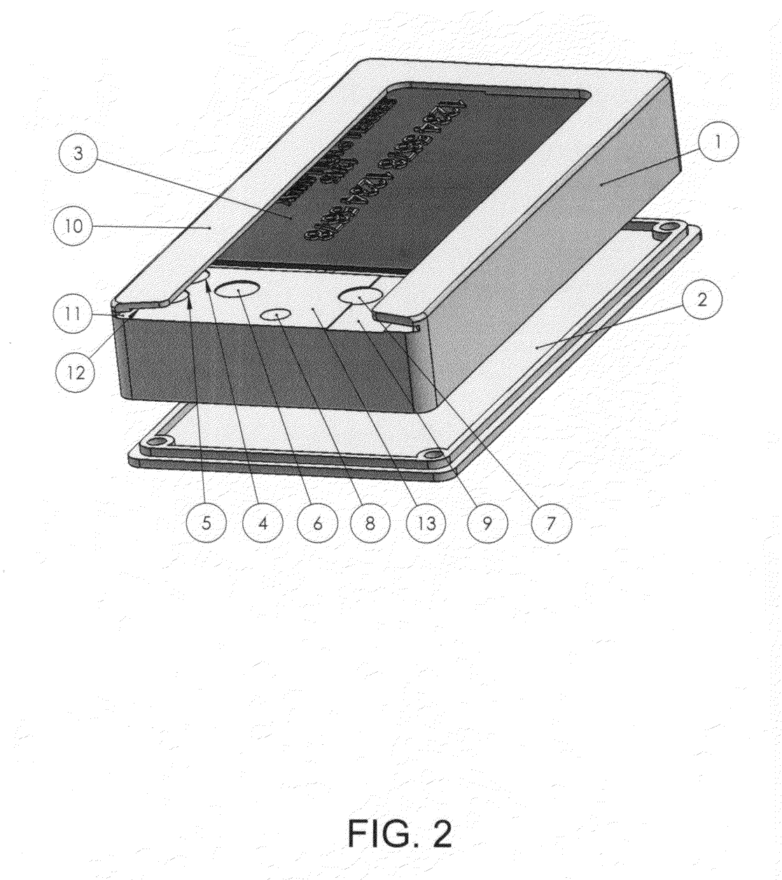

A key element of the invention is the Sensor. The Sensor is connected to the Microprocessor, either directly or through other circuitry. The role of the Sensor is to detect movement of a card into and out off the Enclosure, illustrated in FIG. 2.

The Sensor can be of several types. A magnetic head reader with an amplifying circuit can read the magnetic strip on certain cards. A laser reader can read cards with bar codes. A RFID sensor can read data from that type of card.

The sensor can also be made up a pair of switches that, together, can detect the movement of a card as it is inserted into the Enclosure and as it is retracted from the Enclosure.

In a favorite embodiment, a first switch is placed in front of a second switch so that the direction of movement of the card is easily determined by the Microprocessor by the order in which the switches are activated.

The Microprocessor counts the number of cards that have been inserted and store that information in the attached Memory. When a card is removed, the card count is reduced by one count. If this new count does not match the historical count stored in the Memory, the Microprocessor will issue a warning to the user that a card is missing from the Enclosure.

In the simplest form of the embodiment, a count may not be necessary. The warning process can just start as soon as any card is removed.

In the preferred embodiment, the LED attached to the microprocessor begins to strobe on and off as soon as a card is missing. Then after a suitable delay, the Signaling Device attached to the Microprocessor will begin a more persistent warning. A sound-producing device, such as a piezo element, or a mechanical buzzer, serves as the Signaling Device.

The LED can serve other purposes, such as providing general illumination, if certain switches are activated. A warning need not be in progress.

Finally, the Reset Switch attached to the Microprocessor is used to indicate to the Microprocessor that the warning has been received but the user wishes to return to the quiet, normal state. The Reset Switch is also used indicate to the Microprocessor that the card that was removed will not be returned, for some reason, and that the historical count stored in Memory should be reduced by one. Obviously, if that card, or any other card, is later inserted into the Enclosure, the historical count will be increased by one count.

Referring now to FIG. 2, a preferred embodiment that uses two switches as the card Sensor is illustrated.

The Enclosure consists of Upper Body 1 and the Bottom Cover 2. Card 3 is shown in its stowed position, after being inserted between Lip 10 of Upper Body 1 and Flat Surface 13 in Card Grove 11.

In this embodiment, Switches 4 and 5 are tactile switches with a rounded interface surface. This is accomplished with a glass ball trapped between the tactile switch activator arm and a hole in Upper Body 1 that is designed to be too small for the glass ball to pass through but large enough that a portion on the ball is above the surface. When the card is moved through Card Grove 11, Lip 10 acts as a stationary member forcing the card to ride up the surface of the ball while pressing downward on the switch, effectively translating lateral movement of the card to downward movement at the switch activator arm.

Reset Switch 6 is also positioned on the flat surface of Upper Body 1 so as to be available to the user after Card 3 is fully removed and the user wishes to stop all warning and reset the historical count.

Light Switch 7 is provided to allow the user to activate LED 8 for aid in performing functions in dim lighting.

The spacing between the Lip 10 and Flat Surface 13 is designed so that a card with embossed words or numbers can only be inserted in a single orientation. Embossing Relief 12 provides the only place that the embossing can pass through. That orientation would usually place any magnetic strip over the area of Cutout 9, which is provided as relief for the magnetic strip, often subject to scratches when slid repeatedly over a surface. If a Magnetic Reader Head were to be used in another embodiment, the head would be located in the area of Cutout 9.

Since only a single orientation is possible, other cards, under Card 3, will never have their magnetic strips touching each other. The stripes will always be separated by the thickness of the card.

Not shown in FIG. 2. for simplicity, are the electrical components described in FIG. 1. All of these components are mounted on a printed circuit board just below the surface of the flat surface of Upper Body 1, in a manner that is well known.

In operation, cards are inserted into the Enclosure, one at a time, so that their presence will be sensed by Switch 5 and the Switch 4 as they pass over the switches. The Microprocessor will recognize incoming cards by the fact that switch 5 is activated first, and Switch 4 is activated last. Each card, so inserted will result in a new historical count to be stored in the memory.

In this favorite embodiment, the cards in the Enclosure are supported by some spring means, such as foam. The user must press down the stack of cards each time a card is added to make room for it on top of the stack of cards.

Now, when a card is removed, Switch 4 will be activated before Switch 5. This pattern indicates to the Microprocessor that a card has been removed. It is preferred that LED 8 is used to indicate to the user that a card is missing. A quick strobing of LED 8 would be useful, and without a large consumption of battery power.

After a prescribed amount of time, say five minutes, the Signaling Device, on the printed circuit board in this case, would send an audible signal to the user. At this point, the user may realize that the most recently used card is still missing from the Enclosure. If it is missing due to an oversight, recovery is still likely because of the short amount of time involved. This feature is at the heart of the invention,

If on the other hand, a card is removed from service intentionally, the user may activate Reset Switch 10 and establish a new historical count.

Light Switch 7 may be used anytime extra light is needed to read a menu, find a key, or sign the receipt generated by the use of a card.

Others may find improvements on what is taught herein, without departing from the spirit of the present invention.

I claim:

1. A wallet for managing the secure storage of cards used in transactions Comprising:
a. An enclosure for holding said cards;
b. One or more sensors for detecting the movement of said cards into and out of said enclosure;
c. a microprocessor for recording the data from said sensors;
d. memory for saving said data recorded by said microprocessor;
e. a signaling device for communicating with the user of said wallet;
f. a power source for supplying power to said microprocessor;
Wherein said microprocessor compares said data in said memory with current data resulting from said cards being moved into or out of said enclosure and activates said signaling device whenever an analysis indicates that a card is missing from said enclosure.

2. The wallet in claim 1, wherein said sensor is comprised of two or more switches activated in a particular order when one of said cards is placed into said enclosure and in a different order when one of said cards is removed from said enclosure and said analysis includes comparing the total number of cards last placed into said enclosure with the number of said cards remaining in said enclosure.

3. The wallet in claim 1, wherein said sensor is a Magnetic Stripe Reader and said data is comprised of some portion of the coded information contained in one or more tracks of said card and said analysis includes recognizing that a card with certain coded information has been removed and not returned.

4. The wallet in claim 1, wherein said sensor is a Bar Code Reader and said data is comprised of the coded information contained in the bar code on said card and said analysis includes recognizing that a card with certain coded information has been removed and not returned.

5. The wallet in claim 1, wherein said sensor is a RFID Reader and said data is comprised of the coded information contained in embedded chip of said card and said analysis includes recognizing that a card with certain coded information has been removed and not returned.

6. The wallet in claim 1, wherein said signaling device produces a sound that can be heard by the user.

7. The wallet in claim 1, which also includes a LED which may be illuminated prior to said signaling device producing said sound or may be illuminated in conjunction with said sound.

8. The wallet in claim 1, wherein said power source is comprised of one or more batteries.

9. The wallet in claim 1, wherein said activation of said signaling device is delayed by a prescribed amount of time after said analysis determines that a card is missing.

10. The wallet in claim 1, which also includes a method for resetting the signaling device whenever one or more of said cards are removed permanently or the user wishes to end the signal.

11. The wallet in claim 1, wherein said method includes a reset switch that can be activated by the user.

12. The wallet in claim 2, wherein said switches are comprised of two tactile switches with rounded interface surfaces that translates lateral movement of the card between a stationary member and said switch into a downward movement sufficient to activate said switch.

13. The wallet of claim 1, which also includes an LED for communicating with the user.

14. The wallet of claim 13, which further includes a switch for providing general illumination from said LED for a prescribed period of time.

15. The wallet of claim 1, wherein said microprocessor puts itself to sleep at certain times to extend battery life.

16. A card wallet that signals the user whenever a card is removed from said wallet and not returned.

17. The wallet of claim 15, wherein said signal is produced by an electronic circuit that is capable of detecting that said card has been removed and not replaced.

18. The wallet of claim 16, wherein said electrical circuit includes one or more sensors able to detect the movement of said card in and out of said wallet.

19. A card wallet for storing cards with magnetic stripes wherein said magnet stripes on said cards cannot be placed together due to the design of said wallet.
